(19) United States
(12) Patent Application Publication
(10) Pub. No.: US 2025/0251496 A1
(43) Pub. Date: Aug. 7, 2025

(54) SOFTWARE-DEFINED LIDAR SYSTEMS AND METHODS

(71) Applicant: Lumotive, Inc., Redmond, WA (US)

(72) Inventors: Gleb M. Akselrod, Kenmore, WA (US); Ross D. Uthhoff, Seattle, WA (US); Barry Hugh Friemel, Southport, NC (US)

(21) Appl. No.: 18/433,074

(22) Filed: Feb. 5, 2024

(51) Int. Cl. G01S 7/484; G01S 7/481; G01S 7/4863; G01S 17/931

(52) U.S. Cl. CPC G01S 7/484; G01S 7/4817; G01S 7/4863; G01S 17/931

(57) ABSTRACT

A software-defined lidar system may include a transmitter subsystem and a receiver subsystem to selectively steer and receive optical radiation for detection and ranging. The transmitter subsystem may include a tunable optical metasurface to selectively steer optical radiation at various steering angles toward distant surfaces. The steering angles may be defined in a single dimension for a one-dimensionally steerable metasurface. The steering angles may be defined in two dimensions for a metasurface that is steerable in two dimensions. The software-defined lidar system may also include a controller to operate the transmitter subsystem and the receiver subsystem to scan a first region of interest (ROI) corresponding to a first set of steering angles with a first set of ROI scan parameters and scan a second ROI corresponding to a second set of the steering angles with a second set of the ROI scan parameters.

### TECHNICAL FIELD

This disclosure relates to detection and ranging devices and methods. More particularly, this disclosure relates to light detection and ranging (lidar).

### BRIEF DESCRIPTION OF THE DRAWINGS

FIG. 1 illustrates a perspective view of a simplified block diagram of reflective and resonator layers of a two-dimensional optical metasurface, according to one embodiment.

FIG. 2A illustrates a transmitter subsystem with a two-dimensional metasurface steering optical radiation at two different steering angles, according to one embodiment.

FIG. 2B illustrates the two-dimensional metasurface steering optical radiation to two additional steering angles, according to one embodiment.

FIG. 3 illustrates an example of a one-dimensionally steerable metasurface, according to one embodiment.

FIG. 4A illustrates an example of partial elevation illumination of steered optical radiation by partial activation of a VCSEL array, according to one embodiment.

FIG. 4B illustrates another example of partial elevation illumination of steered optical radiation by activation of a different subset of the VCSEL array, according to one embodiment.

FIG. 5A illustrates a flow chart of operations for quasi-static and real-time scan configurations of a software-defined lidar system, according to various embodiments.

FIG. 5B illustrates a flow chart of operations for additional embodiments of quasi-static and real-time scan configurations of a software-defined lidar system, according to various embodiments.

FIG. 6 illustrates a flow chart of an example real-time scan configuration for a software-defined lidar system, according to one embodiment.

FIG. 7 illustrates a flow chart of an example quasi-static scan configuration for a software-defined lidar system, according to one embodiment.

FIG. 8 illustrates a block diagram of a software-defined lidar system, according to one embodiment.

FIG. 9 illustrates a block diagram of a mechanical lidar system and a graph of a continuously steered lidar scan, according to one embodiment.

FIG. 10 illustrates a block diagram of a virtualized software-defined lidar system and a graph of a non-continuously steered lidar scan of various regions of interest, according to one embodiment.

FIG. 11 illustrates a block diagram of a virtualized software-defined lidar system in which different portions of an image sensor are used for different regions of interest, according to one embodiment.

FIG. 12 illustrates a block diagram of another example of a virtualized software-defined lidar system, according to one embodiment.

FIG. 13 illustrates a block diagram of another example of a virtualized software-defined lidar system, according to one embodiment.

FIG. 14A illustrates a software-defined lidar system used in an augmented reality device, according to one embodiment.

FIG. 14B illustrates a software-defined lidar system used in another augmented reality device, according to one embodiment.

FIG. 15 illustrates a software-defined lidar system used to track a moving object in an environment, according to one embodiment.

FIG. 16 illustrates a software-defined lidar system used in augmented reality glasses, according to one embodiment.

FIG. 17A illustrates a software-defined lidar system used in a vehicle, according to one embodiment.

FIG. 17B illustrates another example of a software-defined lidar system used in a vehicle, according to one embodiment.

FIG. 18 illustrates diagrams of a lidar scan via a software-defined lidar system, according to one embodiment.

FIG. 19 illustrates a table with descriptions of some example ROI scan parameters, according to one embodiment.

### DETAILED DESCRIPTION

Light detection and ranging (lidar) systems have utilized various techniques to steer optical radiation and detect reflected signals from distant surfaces. For example, mechanical scanning systems, such as rotating or oscillating mirrors, may be used to sweep optical radiation between a range of angles. These mechanical scanning systems require mechanically complex and bulky mechanisms, which can limit the speed and agility of the lidar system. Additionally, the moving parts in these systems are prone to wear and tear, leading to reduced reliability and increased maintenance requirements. The optical radiation is typically swept from one extreme angle to another extreme angle at a constant velocity, such that the dwell time is the same at every angle.

Another approach to steering optical radiation in lidar systems involves the use of phased array antennas. These antennas use an array of individual antenna elements, each with its own phase shifter, to control the direction of the emitted radiation. By adjusting the phase of each element, the emitted radiation can be steered towards different angles. However, the use of phased array antennas in lidar systems can be challenging due to the high frequencies involved (e.g., infrared radiation in many instances) and the need for precise phase control. This can result in complex and expensive systems that are not suitable for widespread adoption.

The presently described systems and methods address various shortcomings and limitations of previous lidar systems. The presently described systems and methods also enable functionalities and scanning approaches, such as the virtualization of lidar sensors in a single physical lidar device. The presently described systems and methods propose a software-defined lidar (SWDL) system that allows for dynamic adjustments to scan parameters. In some embodiments, the scan parameters may be dynamically adjusted after image analysis (e.g., via an application-specific or purpose-built perception stack). In other embodiments, the scan parameters may be dynamically adjusted after a set of one or more discrete scans (e.g., before perception stack analysis). As such, this disclosure includes embodiments that allow for real-time configuration and adjustment based on internal analysis of scan data (e.g., re-scanning to compensate for saturation), embodiments that allow for real-time configuration and adjustment based on perception software analysis by a recipient of the lidar scan data (e.g., a software or hardware-based routine or subsystem), and embodiments that are configured or customized for quasi-static operation.

A software-defined lidar system may utilize a tunable optical metasurface in a transmitter subsystem to selectively steer optical radiation at various steering angles toward distant surfaces. Tunable optical metasurfaces allow for fast and precise scanning of multiple regions of interest (ROIs) at various (possibly non-continuous) scanning angles, with configurable dwell times at each scanning angle. The software-defined lidar system includes a receiver subsystem (e.g., lenses, sensors, metasurfaces, mirrors, etc.) to receive the reflected optical radiation from the distant surfaces. A controller operates the transmitter and receiver subsystems to scan different ROIs with different scan parameters.

In one example embodiment, a lidar system includes a transmitter subsystem, a receiver subsystem, and a controller. The transmitter subsystem includes a tunable optical metasurface to selectively steer optical radiation at various steering angles toward distant surfaces. In some embodiments, a one-dimensionally steerable metasurface is utilized to steer scan lines along a single dimension. In other embodiments, a two-dimensionally steerable metasurface may be utilized to allow for steering angles defined in two dimensions. In such embodiments, discrete steering angles may be represented as beamforms that are steered in two dimensions (e.g., along an elevation axis and a steering axis).

The receiver subsystem may include various optical elements and an optical sensor to receive and detect reflected optical radiation from the distant surfaces. Various configurations of receiver subsystems and optical sensors may be used in conjunction with the presently described systems and methods. For example, an optical sensor with a one-dimensional or two-dimensional array of pixels may be used. The receiver subsystem may utilize various lenses, mirrors, and/or optical metasurfaces to steerably receive optical radiation reflected by the distant surfaces.

The lidar system may include a controller to operate the transmitter subsystem and the receiver subsystem to scan various regions of interest (ROIs), each of which corresponds to a different set of steering angles. For example, the system may scan a first ROI corresponding to a first set of steering angles and a second ROI corresponding to a second set of steering angles. Each ROI may be scanned using a different set of ROI scan parameters. For example, each frame of an ROI may be scanned with scan parameters specifying one or more of a scan resolution, scan frame rate, scan refresh rate, detection ranges, dwell times, modulation frequencies, X and Y binning, frame persistence, and the like. The scan parameters may additionally or alternatively specify controls for a laser or other optical radiation generation device, such as specifying a specific power level or pulse duration to be used at various steering angles. The scan definition for an ROI may include specifications for the start and stop angles in the vertical and horizontal directions. In some embodiments, the first ROI may include a first set of steering angles defined in terms of steering angles in a first dimension and steering angles in a second dimension (e.g., azimuth and elevation).

The scan parameters may also be used to specify detector and sensor configurations of the receiver subsystem. For example, the scan parameters may include a scan resolution to be used for a particular ROI. The scan resolution may be a function of the sensor utilized (e.g., number of pixels per scan line, diffraction limitations, etc.) and/or the angular step size between steering angles. For example, if the scan parameters indicate an ROI to be scanned between steering angles 23 degrees and 37 degrees, one possible angular scan resolution might specify a 1-degree angular step size, such that 15 discrete scans are implemented for the ROI. Another possible angular scan resolution might specify a 0.1 degree angular step size, such that 150 discrete scans are implemented for the ROI. The scan resolution may be dynamically adjusted by binning or un-binning photodetectors of a sensor. The scan parameters may also specify an integration time to be used for each pixel or set of pixels (e.g., binned pixels) of the sensor. In some embodiments, the lidar system may be configured with a static configuration to scan any number of different ROIs with static scan parameters for each ROI. In other embodiments, the lidar system may be dynamically or selectively updated to modify the specific steering angles and/or the scan parameters associated with each ROI.

As described herein, a software-defined lidar system can be dynamically programmed for scanning specific ROIs associated with specific steering angles (e.g., one-dimensionally steerable scan lines and/or two-dimensionally steerable beamforms) and ROI scan parameters. The software-defined lidar system may include a transmitter subsystem with a tunable optical metasurface to selectively steer optical radiation at various steering angles toward distant surfaces. A receiver subsystem may receive reflected optical radiation from the distant surfaces. The software-defined lidar system may include a virtualization subsystem to receive a plurality of scan definitions from one or more requestors. Examples of possible “requestors” include disparate systems, subsystems, routines, or subroutines in electronic communication with a lidar system. For example, the requestor may make a request and/or otherwise obtain lidar scan data for a particular ROI using a particular set of ROI scan parameters via an application programming interface (API). Each scan definition may specify an ROI in terms of a set of steering angles (one-dimensional or two-dimensional) and a set of ROI scan parameters to be used when scanning the ROI.

As a specific example, a vehicle may include a collision-avoidance software routine and a parking-assist software routine. The collision-avoidance software routine may require relatively high-quality lidar data (e.g., high refresh rate and high resolution) for a relatively narrow spatial region in front of the vehicle. The parking-assist software routine may utilize relatively low-quality lidar data (e.g., lower refresh rates and/or lower resolution may be adequate) for a relatively wide spatial region that includes the front of the vehicle and the front corners of the vehicle. Traditionally, two separate lidar sensors, each purpose-built for their intended application, would be utilized.

The presently described systems and methods allow for the collision-avoidance software routine and the parking-assist software routine to use virtual lidar sensor data from a single software-defined lidar device. As described herein, the software-defined lidar system may include a single physical transmitter subsystem and a single physical receiver subsystem. The software-defined lidar system may be connected to a data network of the vehicle. The collision-avoidance software routine may use an API of the software-defined lidar to define a first ROI corresponding to a first set of steering angles. The collision-avoidance software may specify ROI scan parameters for the first ROI with a relatively high frame rate, a sufficiently high resolution, and a sufficiently long scan range along the horizon to detect objects (e.g., a person, a sign, a positioning beacon, an animal, a vehicle, etc.) and stop the vehicle before a collision occurs. The parking-assist software routine may define a second ROI (e.g., via the API) corresponding to a second set of steering angles and ROI scan parameters that might include lower refresh rates and/or lower resolution scanning.

As generally described herein, the software-defined lidar system includes a controller that operates the transmitter subsystem and the receiver subsystem to scan each ROI using the associated ROI scan parameters to generate a virtual lidar sensor data set for each ROI. The software-defined lidar device provides (or makes available) the virtual lidar data of each ROI to each respective requestor (e.g., the different vehicle software routines in the specific example above).

In some embodiments, the requestor may process the virtual lidar sensor data set for detection, classification, tracking, and/or segmentation. Each requestor may include a different perception stack for different purposes. The outputs (e.g., detections, classifications, tracked objects, segmentations, etc.) of the perception stack are referred to herein as perception outputs. In some embodiments, the request may modify the scan definition of an ROI based on one or more of the perception outputs. For example, the request may modify or update the steering angles associated with an ROI and/or update the ROI scan parameters used for scanning the ROI.

As a specific example, a virtual reality or augmented reality (V/AR) headset may include a software-defined lidar device. A routine or subsystem of the V/AR headset may utilize lidar scan data from the software-defined lidar device to track the hands of a user within an environment. A first ROI may be defined for scanning and tracking a first hand of the user, and a second ROI may be defined for scanning and tracking a second hand of the user. A third ROI may be defined for scanning other portions of the environment. The first and second ROIs may be associated with ROI scan parameters for high resolution and high frame rate scanning. The third ROI may be associated with lower resolution and/or lower frame rate scanning at greater distances. The lower resolution and frame rates for the third ROI may reduce power consumption, reduce data bandwidth requirements, and/or otherwise free up resources for tracking the hands of the user. The steering angles associated with first and second ROIs may be continually adjusted as the hands of the user are moved relative to the software-defined lidar device.

More generally, a virtualization subsystem of the software-defined lidar device may receive a modification to one or more scan definitions from one or more requestors.

Each modified scan definition may, for example, specify an updated set of steering angles and/or updated ROI scan parameters. As previously described and used throughout this disclosure, the term “steering angle” refers to optical radiation that is one-dimensionally steered or two-dimensionally steered by a one-dimensionally steerable metasurface or a two-dimensionally steerable metasurface, respectively.

In one example embodiment, a software-defined lidar system includes a transmitter subsystem and a receiver subsystem, as described herein. A controller of the software-defined lidar system includes a controller to receive a plurality of scan definitions from one or more requestors. The controller may be associated with a processor that executes instructions stored on a non-transitory computer-readable medium. Each scan definition specifies an ROI corresponding to a set of steering angles and associated ROI scan parameters. The controller operates the transmitter and receiver subsystems to scan each ROI according to the associated ROI scan parameters to generate virtual lidar sensor data sets for each ROI. The controller transmits the virtual lidar sensor data set of each ROI to each respective requestor.

In one embodiment, the controller scans each ROI by generating a plurality of scan table entries, each of which specifies a steering angle and ROI scan parameters. The controller may implement the scan table entries sequentially or non-sequentially. A scan cycle may include implementing a current scan table entry, capturing sensor data for the current scan table entry, processing or analyzing the captured sensor data, and selecting the next scan table entry to be implemented and/or modifying a scan table entry based on the results of the processing or analyzing. In some embodiments, the execution order of the scan table entries and/or the modifications of the scan table entries is made in real-time prior to the virtual lidar data being sent to a requestor. In other embodiments, modifications to the scan table entries and/or order of execution are modified in response to requests from a requestor after the requestor has processed virtual lidar data via a perception stack, as described herein.

Any of a wide variety of tunable optical metasurfaces may be utilized in conjunction with embodiments described herein, including one-dimensionally steerable optical metasurfaces and two-dimensionally steerable optical metasurfaces. In some embodiments, two-dimensional steering is accomplished using a one-dimensionally steerable optical metasurface in conjunction with selective activation of segmented lasers (e.g., VCSELs), as described in the disclosure incorporated by reference herein. Various metasurfaces, configurations, lidar components, transmitter subsystems, receiver subsystems, and the like are described in U.S. Pat. No. 10,451,800 granted on Oct. 22, 2019, entitled “Plasmonic Surface-Scattering Elements and Metasurfaces for Optical Beam Steering;” U.S. Pat. No. 10,665,953 granted on May 26, 2020, entitled “Tunable Liquid Crystal Metasurfaces;” U.S. Pat. No. 11,092,675 granted on Aug. 17, 2021, entitled “Lidar Systems based on Tunable Optical Metasurfaces;” U.S. Pat. No. 11,429,008 granted on Aug. 20, 2022, entitled “Liquid Crystal Metasurfaces with Cross-Backplane Optical Reflectors;” U.S. Patent Publication No. 2012/0194399, published on Aug. 2, 2012, entitled “Surface Scattering Antennas;” U.S. Patent Publication No. 2019/0285798 published on Sep. 19, 2019, entitled “Plasmonic Surface-Scattering Elements and Metasurfaces for Optical Beam Steering;” and U.S. Patent Publication No. 2018/0241131 published on Aug. 23, 2018, entitled “Optical Surface-Scattering Elements and Metasurfaces;” each of which is hereby incorporated by reference in its entirety. Additional elements, applications, and features of surface scattering antennas are described in U.S. Patent Publication No. 2014/0266946, published Sep. 18, 2014, entitled “Surface Scattering Antenna Improvements;” U.S. Patent Publication No. 2015/0318618, published Nov. 5, 2015, entitled “Surface Scattering Antennas with Lumped Elements;” U.S. Patent Publication No. 2015/0318620 published Nov. 5, 2015, entitled “Curved Surface Scattering Antennas;” U.S. Patent Publication No. 2015/0380828 published on Dec. 31, 2015, entitled “Slotted Surface Scattering Antennas;” U.S. Patent Publication No. 2015/0162658 published Jun. 11, 2015, entitled “Surface Scattering Reflector Antenna;” U.S. Patent Publication No. 2015/0372389 published Dec. 24, 2015, entitled “Modulation Patterns for Surface Scattering Antennas;” PCT Application No. PCT/US18/19269 filed on Feb. 22, 2018, entitled “Control Circuitry and Fabrication Techniques for Optical Metasurfaces,” U.S. Patent Publication No. 2019/0301025 published on Oct. 3, 2019, entitled “Fabrication of Metallic Optical Metasurfaces;” U.S. Publication No. 2018/0248267 published on Aug. 30, 2018, entitled “Optical Beam-Steering Devices and Methods Utilizing Surface Scattering Metasurfaces;” U.S. Pat. No. 11,747,446 issued on Sep. 5, 2023, entitled “Segmented Illumination and Polarization Devices for Tunable Optical Metasurfaces;” and U.S. Pat. No. 11,846,865 issued on Dec. 19, 2023, entitled “Two-Dimensional Metasurface Beam Forming Systems and Methods,” each of which is hereby incorporated by reference in its entirety.

Some of the infrastructure that can be used with embodiments disclosed herein is already available, such as general-purpose computers, computer programming tools and techniques, digital storage media, and communication links. Many of the systems, subsystems, modules, components, and the like that are described herein may be implemented as hardware, firmware, and/or software. Various systems, subsystems, modules, and components are described in terms of the function(s) they perform because such a wide variety of possible implementations exist. For example, it is appreciated that many existing programming languages, hardware devices, frequency bands, circuits, software platforms, networking infrastructures, and/or data stores may be utilized alone or in combination to implement a specific control function.

It is also appreciated that two or more of the elements, devices, systems, subsystems, components, modules, etc. that are described herein may be combined as a single element, device, system, subsystem, module, or component. Moreover, many of the elements, devices, systems, subsystems, components, and modules may be duplicated or further divided into discrete elements, devices, systems, subsystems, components, or modules to perform subtasks of those described herein. Any aspect of any embodiment described herein may be combined with any other aspect of any other embodiment described herein or in the other disclosures incorporated by reference, including all permutations and combinations thereof, consistent with the understanding of one of skill in the art reading this disclosure in the context of such other disclosures.

To the extent used herein, a computing device, system, subsystem, module, driver, or controller may include a processor, such as a microprocessor, a microcontroller, logic circuitry, or the like. A processor may include one or more special-purpose processing devices, such as application-specific integrated circuits (ASICs), programmable array logic (PAL), programmable logic array (PLA), a programmable logic device (PLD), field-programmable gate array (FPGA), or another customizable and/or programmable device. The computing device may also include a machine-readable storage device, such as non-volatile memory, optical memory, flash memory, or another transitory or non-transitory machine-readable storage media. Various aspects of some embodiments may be implemented or enhanced using hardware, software, firmware, or a combination thereof.

The components of some of the disclosed embodiments are described and illustrated in the figures herein to provide specific examples. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure.

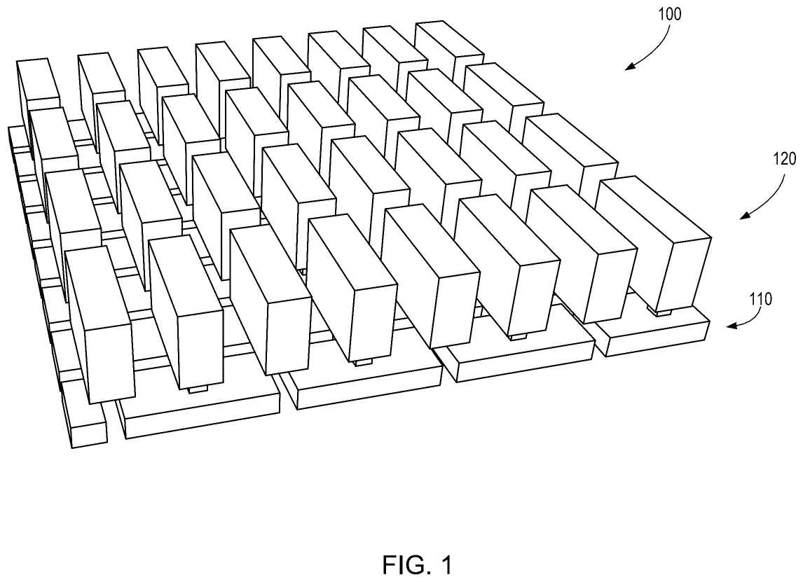

FIG. 1 illustrates a perspective view of a simplified block diagram of a reflective layer 110 and resonator layer 120 of a two-dimensional optical metasurface 100, according to one embodiment. As illustrated, the resonator layer 120 includes a two-dimensional array of metallic optical pillars (rectangular pillars) arranged in parallel rows. Each pillar in the resonator layer 120 extends vertically relative to an underlying substrate layer (not shown). Additional examples and details related to two-dimensional tunable optical metasurfaces are described in U.S. Pat. No. 11,856,865 titled “Two-dimensional Metasurface Beam Forming Systems and Methods,” granted on Dec. 19, 2023, which application is incorporated herein by reference in its entirety.

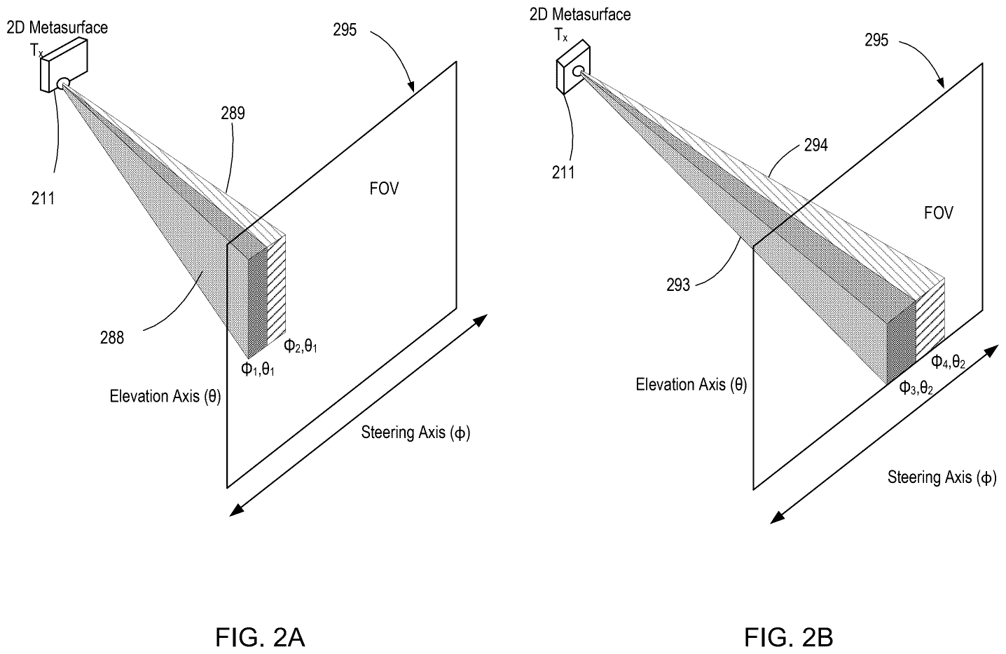

FIG. 2A illustrates a transmitter subsystem with a two-dimensional metasurface 211 to steer optical radiation at two different steering angles 288 and 289 and corresponding to regions of interest (ROIs) within a field of view (FOV) 295 of the two-dimensional metasurface 211, according to one embodiment. According to the illustrated embodiment, the transmitted optical radiation is steered along an azimuth axis at an angle, q. As is generally understood in the concept of LiDAR detection systems, the transmitted optical radiation may rebound off one or more distant objects (e.g., surfaces of objects) and return as rebounded optical radiation to be detected and measured by a detection system.

FIG. 2B illustrates the two-dimensional metasurface 211 steering optical radiation to two additional steering angles 293 and 294, according to one embodiment. In the illustrated embodiment, the two-dimensional metasurface 211 selectively steers optical radiation at the various steering angles 288, 289, 293, 294 in the form of two-dimensionally constrained steering angles (e.g., beamforms).

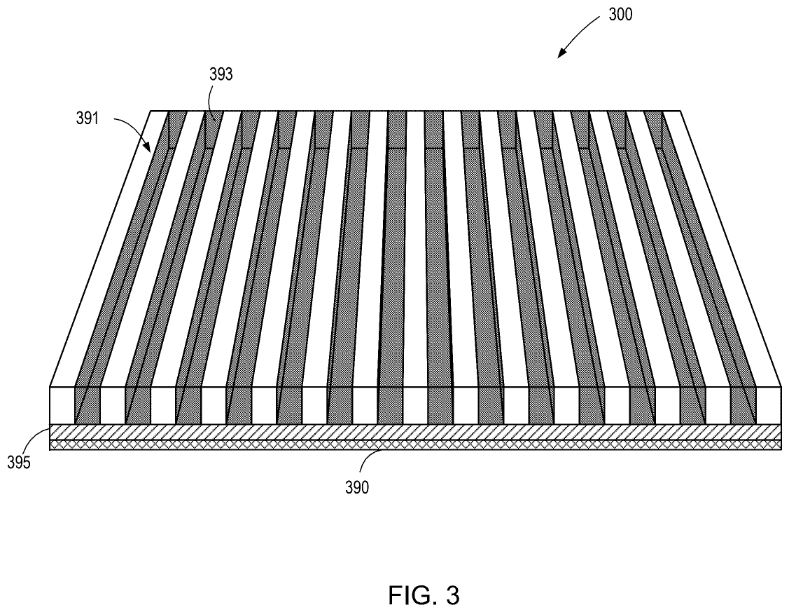

FIG. 3 illustrates an example of a one-dimensionally steerable metasurface 300, according to various embodiments. The tunable metasurface 300 can, for example, be used as part of a solid-state optical transmitter subsystem, receiver subsystem, or transceiver system of a software-defined lidar device. As illustrated, the tunable metasurface 300 includes an optically reflective substrate 390 and a dielectric layer 395. A plurality of elongated rails 391 may be arranged at sub-wavelength intervals on the optically reflective substrate 390. Liquid crystal or another refractive index tunable dielectric material 393 may be positioned between the elongated rails 391, as described in the context of the various one-dimensionally steerable metasurfaces described in the references incorporated herein by reference. The metasurface 300 can be used for one-dimensional beam steering of optical radiation at various steering angles (e.g., scan lines steering along a single axis).

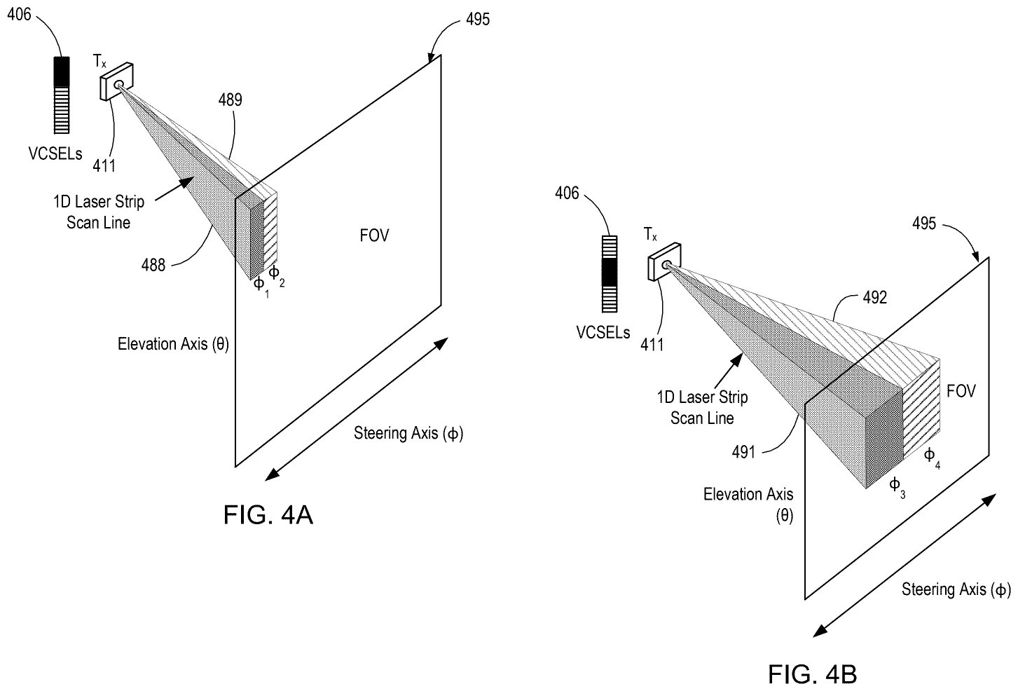

FIG. 4A illustrates an example of partial elevation illumination of steered optical radiation by partial activation of a VCSEL array 406, according to one embodiment. In the illustrated example, the top rows of the VCSEL array 406 are activated to generate an optical radiation incident on a metasurface 411 tuned to steer a first transmitted scan line 488 at a first steering angle, φ1, into the far field of a region 495. An angle of illumination along an elevation axis, θ, of the first scan line 488 corresponds to the dynamically activated rows of the VCSEL array 406. The angle of illumination along the elevation axis, θ, may also affected by static optical characteristics of lenses, lenslet arrays, prisms, diffusers, field-of-view expanders, and the like that deflect transmitted optical radiation along the elevation axis, θ, after being steered by the metasurface 411.

For example, in a software-defined lidar device, the first scan line 488 at the first steering angle, φ1, illuminates objects in the far field of the region 495 that reflect or rebound at least some of the transmitted optical radiation to be received by a receiver subsystem (not shown). A lidar controller (not pictured) may perform time-of-flight calculations (e.g., indirect and/or direct time-of-flight calculations) based on the time the first scan line 488 is transmitted and when reflected/rebounded optical radiation is received by a sensor of the receiver system. The lidar controller uses the time-of-flight calculations to calculate or otherwise determine lidar detection data (e.g., in the form of point cloud data), such as distance and ranging information, movement detection, motion detection, amplitude of returned signals, phase shifts of returned signals, and the like. Processing systems, such as perception stacks to generate various perception data and perception output, may be used to generate images of objects in the far field and/or implement other detection, classification, tracking, and/or segmentation operations.

As illustrated, the lidar controller may then tune the metasurface 411 to steer a second transmitted scan line 489 at a second steering angle, φ2, with only the upper rows of the VCSEL array 406 activated again. The process can be repeated for any number of steering angles along the azimuth axis. A target resolution in the azimuth axis can be attained by adjusting the width of each scan line and the number of scan lines within a given region. A target resolution in the elevation axis can be attained by using a sensor with a suitable number of optical detectors along the elevation axis. For a given number of sensor or detector elements (including binned or un-binned detector pixels), the resolution in the elevation axis can be increased by activating a different subset of the rows of the VCSEL array 406 at the first and second steering angles (e.g., to illuminate a lower portion(s) of the region 495 at the same steering angles).

Various combinations of steering angles along the steering axis can be attained by tuning the metasurface 411. Similarly, various combinations of effective steering angles are possible along the elevation axis by selectively activating different rows of the VCSEL array 406. The refresh rate and/or frame rate of lidar detection is based, at least in part, on the time it takes for the scan lines to scan a region of interest (ROI) in the far field along both the steering axis (by tuning the metasurface) and the elevation axis (by selective activation of different rows of the VCSEL array 406).

FIG. 4B illustrates another example of partial elevation illumination of steered optical radiation by activation of a different subset of the VCSEL array 406, according to one embodiment. As illustrated, a controller tunes the metasurface 411 to steer optical radiation 491 and 492 at steering angles φ3 and φ4 with a middle subset of the VCSEL array 406 activated (shown with shading).

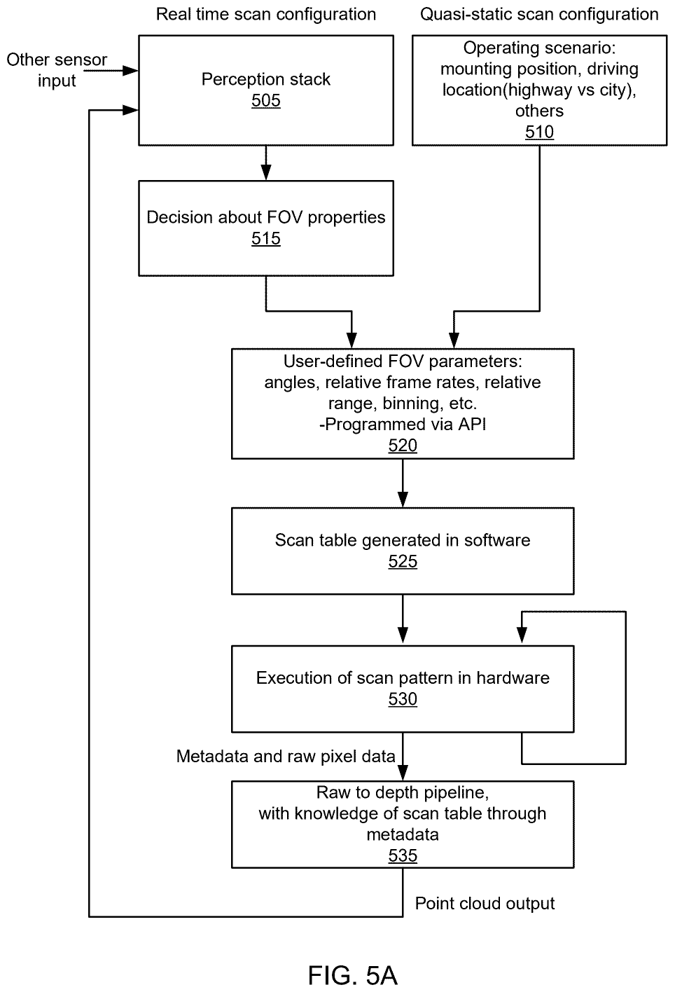

FIG. 5A illustrates a flow chart of operations for quasi-static and real-time scan configurations of a software-defined lidar system, according to various embodiments. In a quasi-static scan configuration, an operating scenario, 510, for a software-defined lidar device may be used to define field-of-view (FOV) parameters. For example, a user or control system may define FOV parameters to include a plurality of scan definitions for the software-defined lidar device. Each scan definition may specify a particular region of interest (ROI) within the total FOV of the lidar device and further include specific scan parameters to be used for scanning each ROI. Each ROI may correspond to a set of steering angles (e.g., a continuous range of steering angles or discontiguous ranges of steering angles). The scan definition may define, for example, ROI scan parameters such as steering angles, relative frame rates, relative range, pixel binning for a detector sensor, dwell times for transmission, integration times for pixels, and the like, at 520. These ROI scan parameters may be programmed using an API of the software-defined lidar device.

The software-defined lidar device may generate, at 525, a scan table that specifies control settings for the transmitter and receiver subsystems of the software-defined lidar device. The controller then executes, at 530, the scan table to control the operation of the transmitter subsystem (e.g., drive a laser assembly and tune a metasurface) and a receiver subsystem (e.g., control a detector sensor readout). Raw pixel data and/or metadata from the receiver subsystem is pipelined and/or otherwise compiled and processed, at 535, to generate lidar sensor data for each ROI, which may be in the form of point cloud output data.

In some embodiments, the point cloud output data for each ROI is provided as virtual lidar sensor data to one or more user devices or software routines. The software-defined lidar device may continue to operate in the quasi-static scan configuration indefinitely by continuing to provide virtual lidar sensor data for one or more ROIs using different ROI scan parameters.

In some embodiments, the point cloud output or other virtual lidar scan data may be provided to a perception stack 505. The perception stack 505 may process and/or otherwise analyze the data (optionally with other sensor input data) to make decisions, such as detection, classification, tracking, and/or segmentation decisions. The perception outputs from the perception stack 505 may include decisions about the field-of-view properties 515, such as modifications to be made to existing scan definitions that update or otherwise modify the ROI steering angles and/or other ROI scan parameters. As such, the software-defined lidar device may be operated in a real-time scan configuration in which the scan definitions for one or more ROIs are updated, deleted, and/or added in real-time.

FIG. 5B illustrates a flow chart of operations for additional embodiments of quasi-static and real-time scan configurations of a software-defined lidar system, according to various embodiments. As described in conjunction with FIG. 5B, in a quasi-static scan configuration, an operating scenario, 510, for a software-defined lidar device may be used to define field-of-view (FOV) parameters. The scan definition may define, for example, ROI scan parameters such as steering angles, relative frame rates, relative range, pixel binning for a detector sensor, dwell times for transmission, integration times for pixels, and the like, at 520.

The software-defined lidar device may generate, at 525, a scan table that specifies control settings for the transmitter and receiver subsystems of the software-defined lidar device. The controller then executes, at 530, the scan table to control the operation of the transmitter subsystem (e.g., drive a laser assembly and tune a metasurface) and a receiver subsystem (e.g., control a detector sensor readout). The raw pixel data and/or metadata from the receiver subsystem may be calibrated or otherwise adjusted, at 532, based on the temperature of the laser. This detection, calibration, or adjustment may be done via an application-specific integrated circuit (ASIC) or programmable logic device (PLD), such as a field-programmable gate array (FPGA). The calibrated data may then be pipelined and/or otherwise compiled and processed, at 535, to generate lidar sensor data for each ROI, which may be in the form of point cloud output data. A similar approach, with calibration based on laser temperature, at 532, may be implemented for real-time scan data based on outputs of a perception stack, 505, as described in conjunction with FIG. 5A.

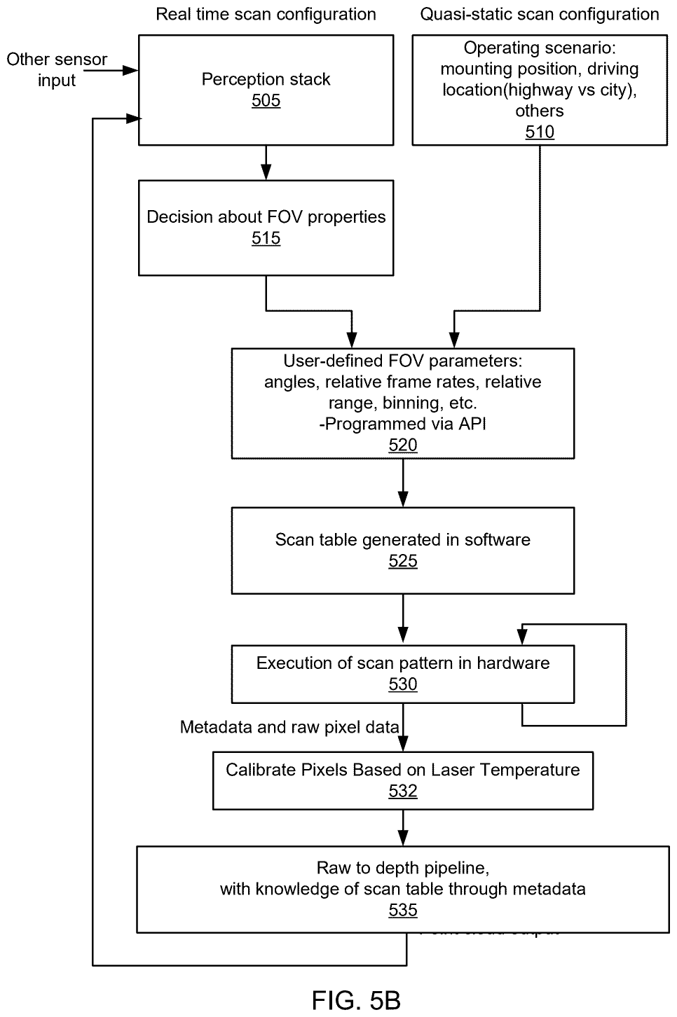

FIG. 6 illustrates a flow chart of an example real-time scan configuration for a software-defined lidar system, according to one embodiment. In the illustrated embodiment, user-defined FOV parameters 605 include one or more scan definitions for ROIs that specify one or more sets of continuous or discontiguous steering angles and ROI scan parameters. Scan table entries are generated, at 610, in software. A controller of the software-defined lidar device implements, at 615, a first or “current” entry in the scan table by controlling the transmitter subsystem and/or the receiver subsystem to scan a scan line or beamform using the ROI scan parameters at the steering angle specified in the current entry.

Metadata and/or raw pixel data is captured by the receiver subsystem and packaged, at 620, into a depth pipeline (e.g., using knowledge of the scan table available via the metadata). Point cloud data is provided to a perception stack, 625, for analysis and processing. The perception outputs of the perception stack, 625, are used to select which single scan entry to use next, at 630, and/or to make modifications to one or more scan entries in the scan table.

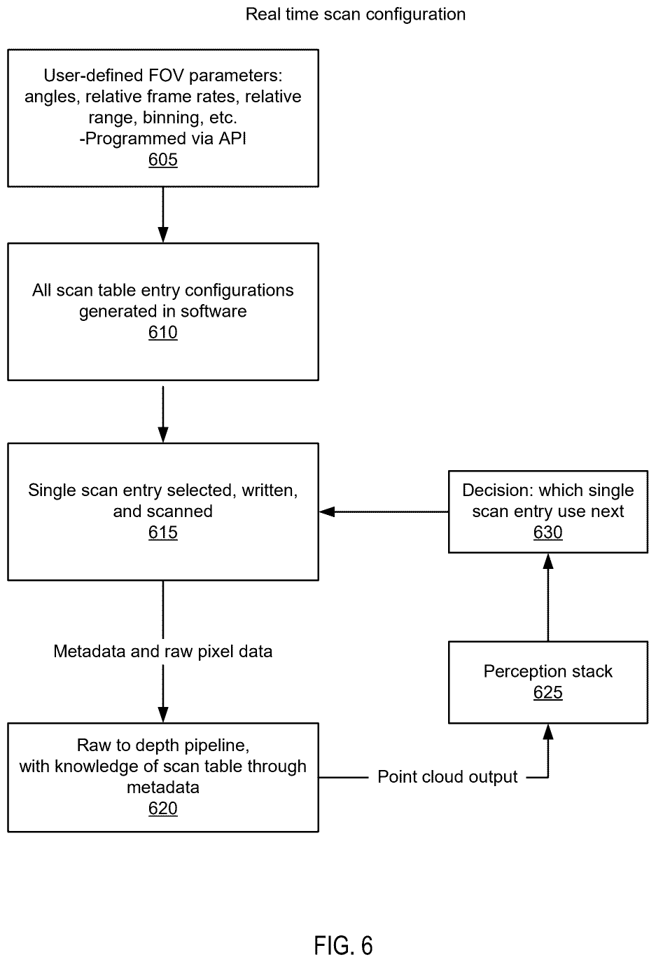

FIG. 7 illustrates a flow chart of an example quasi-static scan configuration 605 for a software-defined lidar system, according to one embodiment. As illustrated, user-defined FOV parameters, 710, include one or more scan definitions for ROIs that specify one or more sets of continuous or discontiguous steering angles and ROI scan parameters. A scan table with a plurality of scan table entries is generated, at 715, for controlling the subsystem of the software-defined lidar device. The specific scan tables to be implemented may be selected, at 720, based on a user-selected or automated computer-selected operation scenario. For example, a set of scan table entries for a software-defined lidar device in a vehicle may be applicable when operating the vehicle on a highway, and a different set of scan table entries may be applicable when operating the vehicle in a city.

A controller of the software-defined lidar device then implements a fixed sequence of single scan entries, at 725. The next single scan entry in the predefined sequence is selected, at 730, written, and scanned, at 735. The metadata and raw pixel data are used to pipeline and output point cloud data, at 740. The process repeats by selecting the next scan entry, at 730, for repeated execution and scanning.

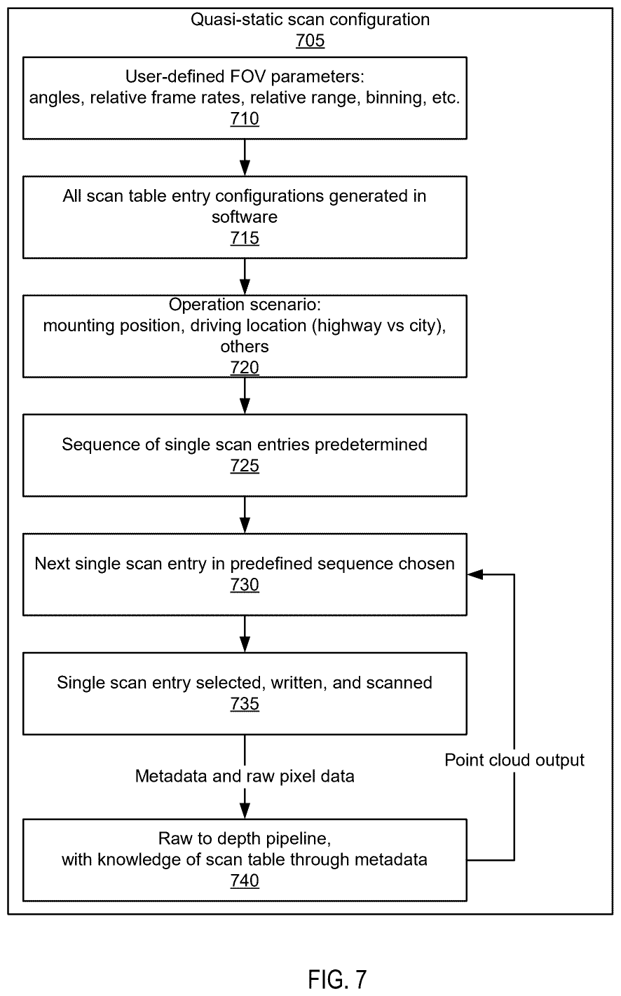

FIG. 8 illustrates a block diagram of a software-defined lidar system 800, according to one embodiment. As illustrated, the software-defined lidar system 800 includes bus 820 that connects a computer-readable storage medium 870, a controller 899, a transmitter subsystem 895, a receiver subsystem 890, a processor 830, a memory 840, and a network interface 850.

The transmitter subsystem 895 includes a laser assembly 896 to generate optical radiation and a tunable optical metasurface 897 to selectively steer the optical radiation at various steering angles toward distant surfaces. The receiver subsystem 890 includes a detector array 892 to receive reflected optical radiation from the distant surfaces. An optical assembly 891 may be used to focus, climate, shape, filter, or otherwise modify the optical radiation prior to being detected by the detector array 892. In some embodiments, the optical assembly 891 may include a tunable optical metasurface or other configurable optics to steerably receive the reflected optical radiation at a receive steering angle that corresponds to the transmit steering angle used by the transmitter subsystem 895.

The controller 899 operates the receiver subsystem 890 and the transmitter subsystem 895 to implement the individual scan entries that cumulatively correspond to various ROIs to be scanned using specified ROI scan parameters. For example, the controller 899 may include a driver or be in communication with a driver to apply voltage patterns to the tunable metasurface 897 to control the steering thereof. The processor 830 may execute the instructions stored within the computer-readable storage medium 870 to implement the various modules or subsystems, including the virtualization subsystem 880, a scan table database 882, an ROI definitions database 884, a raw to depth pipelining subsystem 886, a scan entry selection subsystem 888, and an ROI scan parameters database 889.

The virtualization subsystem 880 may receive a plurality of scan definitions from one or more requestors via the network interface 850 (e.g., via an API). Each scan definition may specify an ROI corresponding to a set of steering angles that can be stored within an ROI definitions database. For each ROI, the scan definition may also include a set of associated ROI scan parameters that can be stored in the ROI scan parameters database 889. The system may generate a scan table of scan table entries to be stored within the scan table database 882. The scan table entries are executable by the controller 899 and/or the processor 830 to operate the receiver subsystem 890 and transmitter subsystem 895 to implement the individual scan lines or scan segments of each ROI. The raw-to-depth pipelining subsystem 886 collects the raw sensor data and, together with metadata from the scan table database 882, pipelines the raw data to generate virtual lidar sensor data for each ROI (e.g., point cloud data).

In some embodiments, the software-defined lidar system 800 implements a static or quasi-static sequence of scan table entries from the scan table database 882 to provide point cloud data for the variously defined ROIs as virtual lidar sensor data to any number of external requestors via the network interface 850 (e.g., to connected devices, software routines, other systems, other subsystems, etc.). In other embodiments, internal analysis of the raw data and/or compiled and pipelined point cloud data may be analyzed by the scan entry selection subsystem 888 to determine which scan entry within the scan table database 882 should be implemented next. In other embodiments, externally connected devices may communicate via the network interface network interface 850 to direct the scan entry selection subsystem 888 as to which scan entry or set of scan entries should be implemented next.

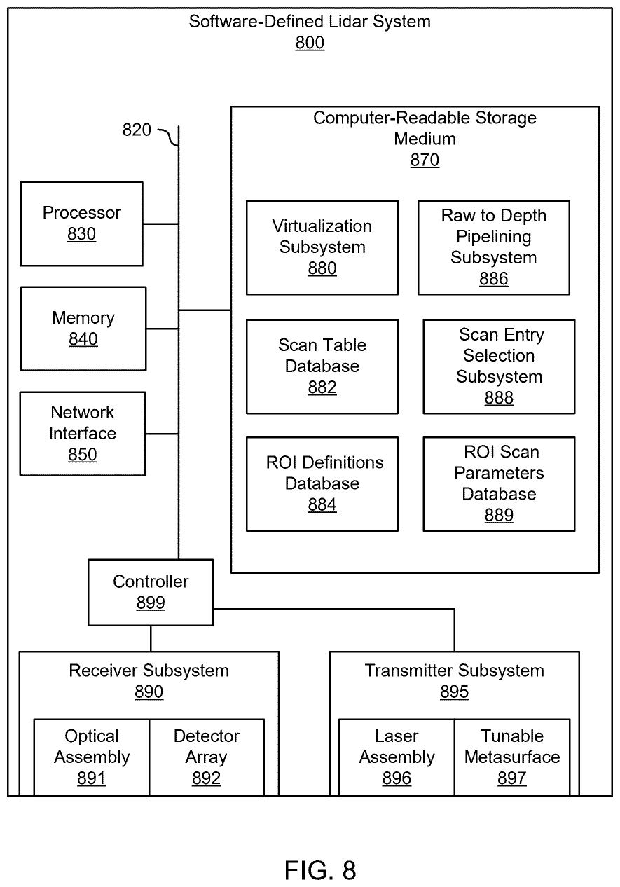

FIG. 9 illustrates a block diagram of a mechanical lidar system 900 and a graph 905 of a continuously steered lidar scan, according to one embodiment. In the illustrated embodiment, a single physical lidar sensor 915 is programmed with a scan definition 910 that specifies the operation of the lidar sensor 915. For example, as provided in graph 905, the lidar sensor 915 may be continuously swept between a first angle and a second angle according to a fixed sequential angle order. A detector of the lidar sensor 915 captures reflected optical radiation using a pre-programmed and static set of capture parameters, such as a fixed dwell time per pixel. A single physical data link 920 provides raw sensor data to a depth processor 925 to export point cloud data over an ethernet port 930.

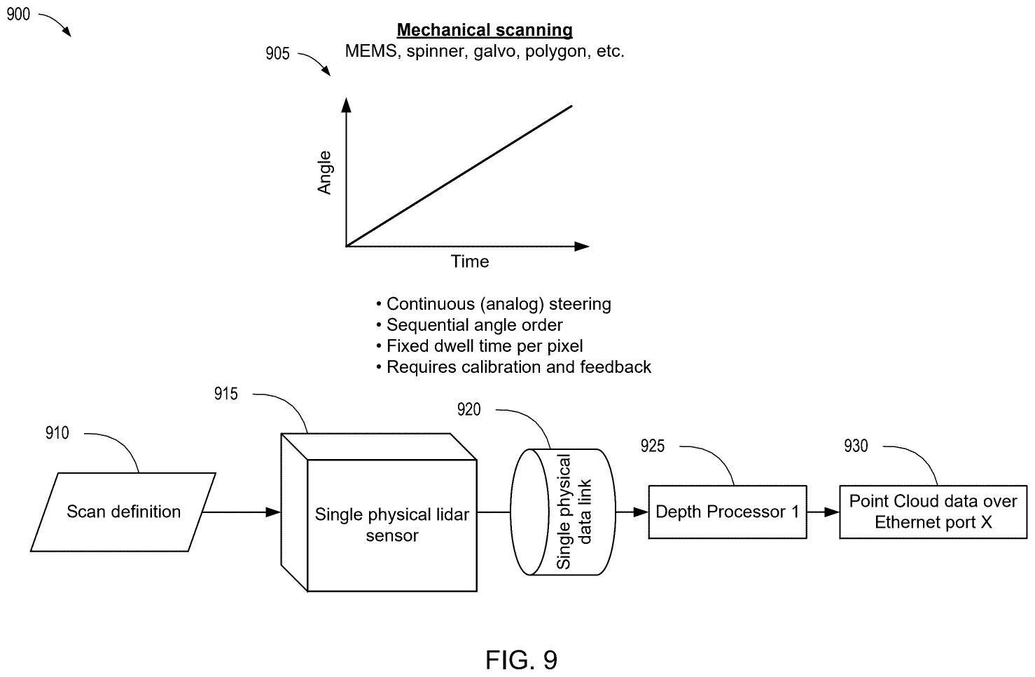

FIG. 10 illustrates a block diagram of a virtualized software-defined lidar system 1000 and a graph 1001 of a non-continuously steered lidar scan of various regions of interest, according to one embodiment. As illustrated, a single physical lidar sensor 1015 is programmed with various scan definitions 1010. As described herein, each scan definition specifies one or more ROIs and accompanying ROI scan parameters. The ROIs may be scanned using transmitter and receiver subsystems, as described herein, with various discrete steering angles and dwell times, as represented in the graph 1001. The scan may include scans at discrete steering angles with arbitrary dwell times. Non-sequential steering angles may be scanned in any order, such that arbitrary frame rates may be implemented for any given steering angle or set of steering angles.

The raw sensor data may be pipelined and packaged via a single physical data line 1020 for virtualization. Sensor data for one or more ROIs may be packaged as virtual sensor data, at 1025, for depth processing, at 1030, and data transfer via one or more ethernet ports. The system may implement any number of virtual sensors. In the illustrated example, virtual sensors 0-N are depicted, where N is an arbitrary integer value. Corresponding depth processors 0-N provide point cloud data over ethernet ports X+N, again where N is an arbitrary integer value. In some embodiments, the point cloud data for each virtual sensor may be transmitted via a unique data communication port (e.g., a unique ethernet port). In other embodiments, data for more than one virtual sensor may be transmitted over the same communication line (e.g., wirelessly, wired, via ethernet, optical, etc.). Each virtualized sensor 1025 can have a different ROI, different ROI scan parameters, a unique depth processor configuration, and/or unique data stream definition. Connected devices requesting specific sensor data for ROIs using specific ROI scan parameters receive virtual lidar sensor data. A single software-defined physical lidar system can provide virtual lidar sensor data to multiple external devices or systems. From the perspective of the connected devices and systems, the virtual lidar sensor data is indistinguishable from the sensor data they would receive from a dedicated purpose-built lidar sensor.

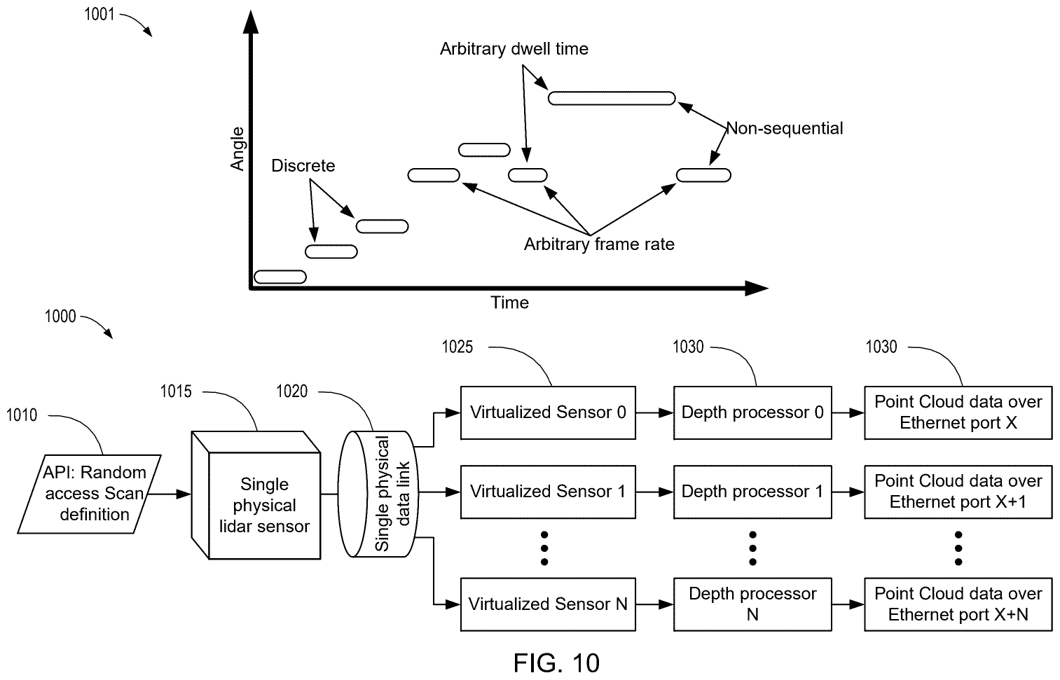

FIG. 11 illustrates a block diagram of a virtualized software-defined lidar system in which different pixel groups of an image sensor 1115 are used to define different ROIs, according to one embodiment. A scan definition 1110 may be sent via an API. The lidar system scans a region using specified scan parameters. If the ROI that is scanned with specified scan parameters has parameters that are compatible with more than one virtualized sensor, the ROI can be scanned a single time, and the raw data from the single physical data link 1120 can be used for more than one virtualized sensor 1125. Alternatively, if the ROIs of two VSs have spatial overlap and incompatible ROI scan parameters, then the overlapping portion of the ROIs may be scanned more than once.

In the illustrated example, the ROI-0 is used by only Virtual Sensor-0 (VS-0), ROI-1 is used by VS-0 and VS-1, ROI-2 is used by VS-1 and VS-7, ROI-3 is used by VS-7, and ROI-4 is used by VS-1 and VS-7. Any given ROI may be used by any number of virtual sensors. As previously described, the ROIs may be scanned sequentially or non-sequentially to generate virtual sensor data for depth processing 1130 and point cloud data export 1135.

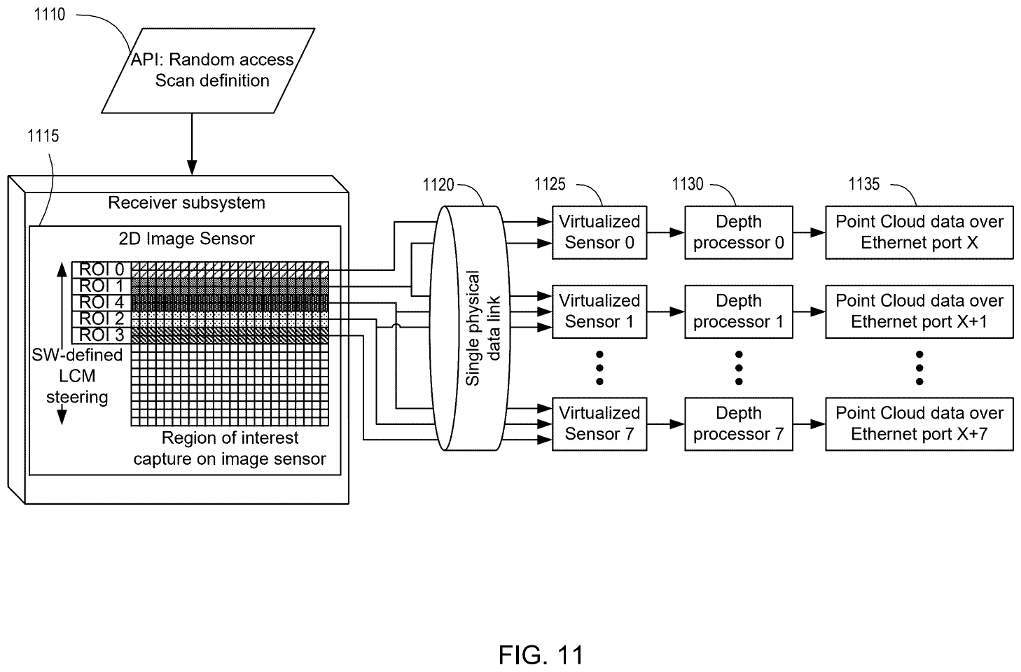

FIG. 12 illustrates a block diagram of another example of a virtualized software-defined lidar system, according to one embodiment. Scan definitions, 1210, are provided to the single physical lidar device 1211 (e.g., via an API). ROIs are scanned via a laser transmitter 1212 and a two-dimensional sensor 1213 to provide virtualized sensor data for any number of virtualized sensors 1225 via a single physical data link 1220. The single physical lidar device 1211 scans the ROIs using the ROI scan parameters specified by the scan definitions. If any ROI has scan parameters that are compatible with more than one virtualized sensor 1225, scan data from the ROI may be used to compile or pipeline the data used by more than one virtualized sensor 1225.

As previously described, one-dimensionally steerable metasurfaces may be used to steer scan lines of optical radiation at various steering angles in a single steering direction. A two-dimensionally steerable metasurface (i.e., a metasurface that is steerable in two dimensions) may be used to steer beamforms of optical radiation at various steering angles defined in two steering directions (e.g., elevation and azimuth). The illustrated example includes the use of a one-dimensionally steerable metasurface (not shown) in conjunction with an addressable VCSEL array that can be used to achieve two-dimensional scanning, as described in detail in the references cited and incorporated by reference herein. Various fields of view (FOVs) may be scanned by the software-defined addressable VCSEL.

Data from various regions of interest corresponds to different fields of view at various corresponding steering angles. As illustrated, the ROIs correspond to groupings of pixel sensors on a two-dimensional image sensor 1213. The scanning is steered in one dimension by steering a liquid crystal metasurface (LCM) and steered in the other dimension by the software-defined addressable VCSELs.

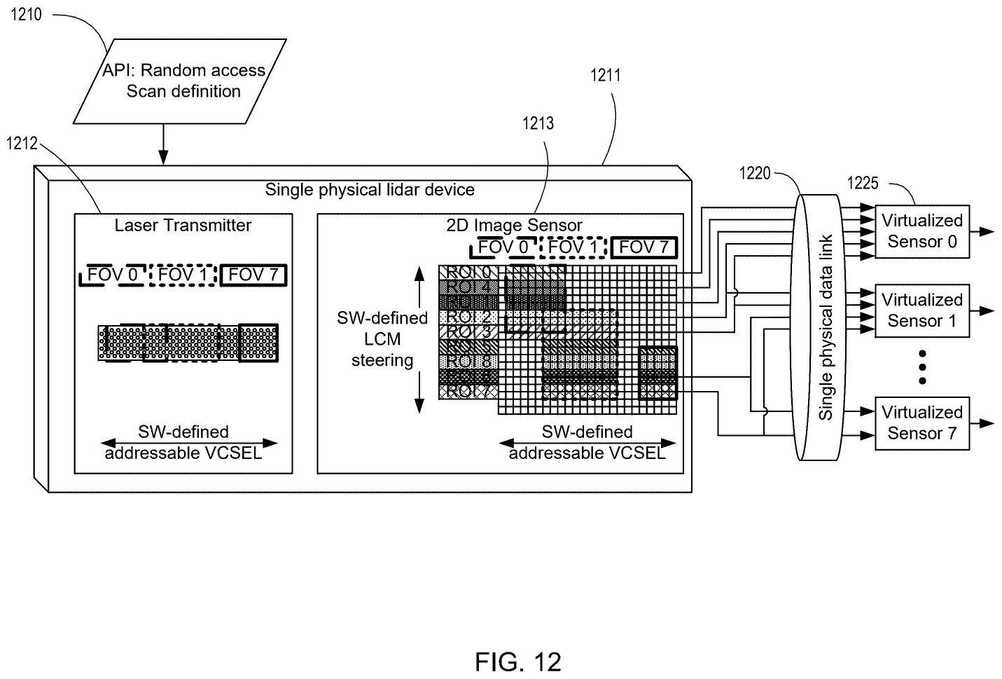

FIG. 13 illustrates a block diagram of another example of a virtualized software-defined lidar system, according to one embodiment. In the illustrated embodiment, virtualized sensors 1325 provide lidar sensor data for specific ROIs to depth processors 1330 that is exported as point cloud data 1335 to various requestors (other devices, subsystems, software routines, perception stacks, etc.). A single physical data link 1320 provides pipelines and packages the raw sensor data for the ROIs of each respective virtualized sensor 1325. As in previous examples, each ROI corresponds to a grouping of sensor pixels on the two-dimensional image sensor 1318 of the receiver subsystem 1315. The groupings of sensor pixels for each ROI correspond to a spatial ROI within the field of view of the transmitter subsystem (not shown) of the software-defined lidar system.

The transmitter subsystem may be steerable in two directions. For example, a two-dimensionally steerable metasurface may be used to steer optical radiation at various steering angles constrained in both directions. In other examples, a one-dimensionally steerable metasurface may be used to steer the optical radiation in one dimension, and a software-defined addressable laser array may be used to steer the optical radiation in the other dimension. The different ROIs are identified by various fill patterns in the illustration and correspond to different fields of view illuminated by the transmitter subsystem. The scan definitions 1310 specify the ROIs and the associated ROI scan parameters.

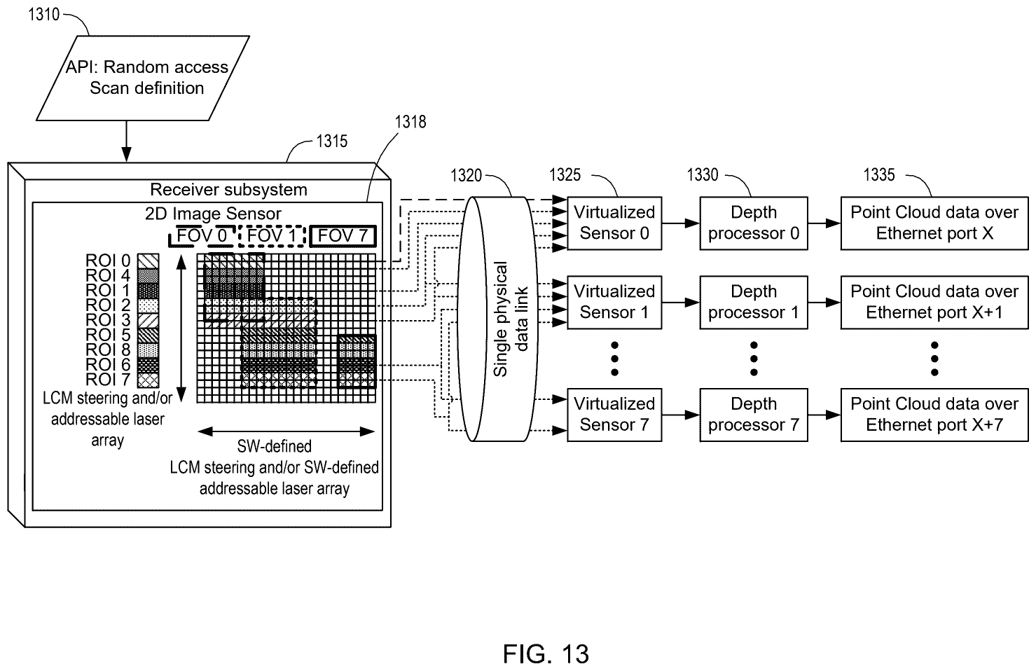

FIG. 14A illustrates a software-defined lidar system used in an augmented reality device 1450, according to one embodiment. Any of the various embodiments of software-defined lidar systems described herein may be utilized in the augmented reality device 1450. The system may detect an object 1480 within a field of view 1495. The software-defined lidar system may be dynamically adjusted to scan the ROI that includes the detected object with a longer range, a higher resolution, a higher frame rate, and/or other ROI scan parameters that are different than those used for other ROIs within the field of view 1495 that do not include the detected object 1480.

FIG. 14B illustrates a software-defined lidar system used in the augmented reality device 1450 to track the movement of a user's hands, according to one embodiment. In the illustrated embodiment, the software-defined lidar system scans a first ROI 1470 that is less important with a relatively low frame rate and low scanning resolution to conserve power, reduce heat generation, and/or otherwise allow for the allocation of limited resources (bandwidth, data storage, processing power, etc.) to ROIs that are more important. The ROIs 1481 and 1482 include the detected hands of a user and may be scanned using ROI scan parameters with a higher frame rate and higher resolution. The steering angles corresponding to the ROIs 1481 and 1482 may be dynamically modified and updated as the user's hands move.

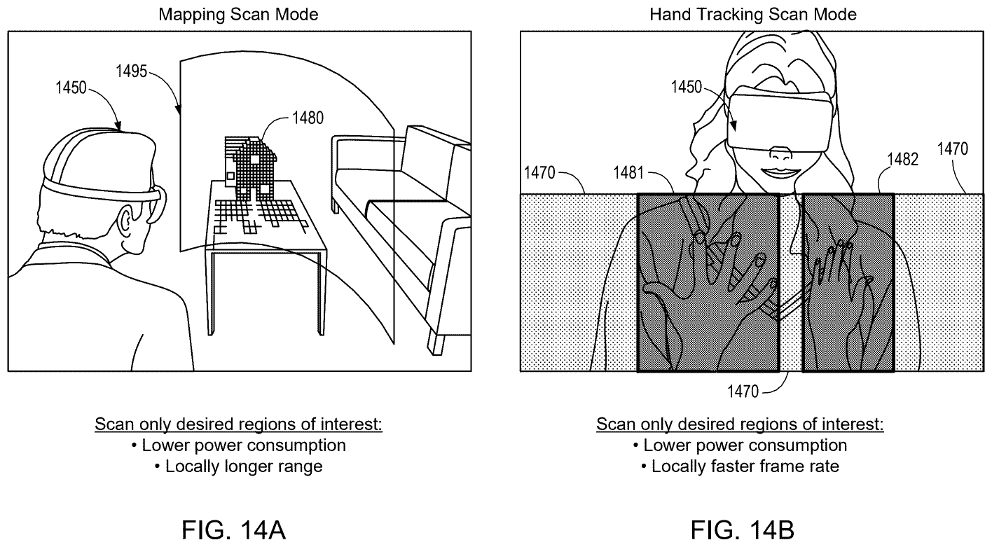

FIG. 15 illustrates a software-defined lidar system used to track a moving object in an environment, according to one embodiment. The software-defined lidar system may scan an entire field of view as a first ROI 1510 with ROI scan parameters that use a low level of available resources. Upon detection and/or classification of the moving person 1550, the software-defined lidar system dynamically implements two additional ROIs. A second ROI 1520 is created to scan the immediate location of the person 1550 with ROI scan parameters that consume a high level of available resources. For example, the second ROI 1520 may be scanned with ROI scan parameters that specify a relatively high frame rate, a longer range, and/or a higher resolution. A third ROI 1530 is created to scan possible locations where the person 1550 may move with ROI scan parameters that use a medium level of available resources. For example, the ROI scan parameters of the third ROI 1530 may be selected to have frame rates, scan ranges, scan resolutions, dwell times, laser power levels, etc., that are between those used in the first ROI 1510 and the second ROI 1520.

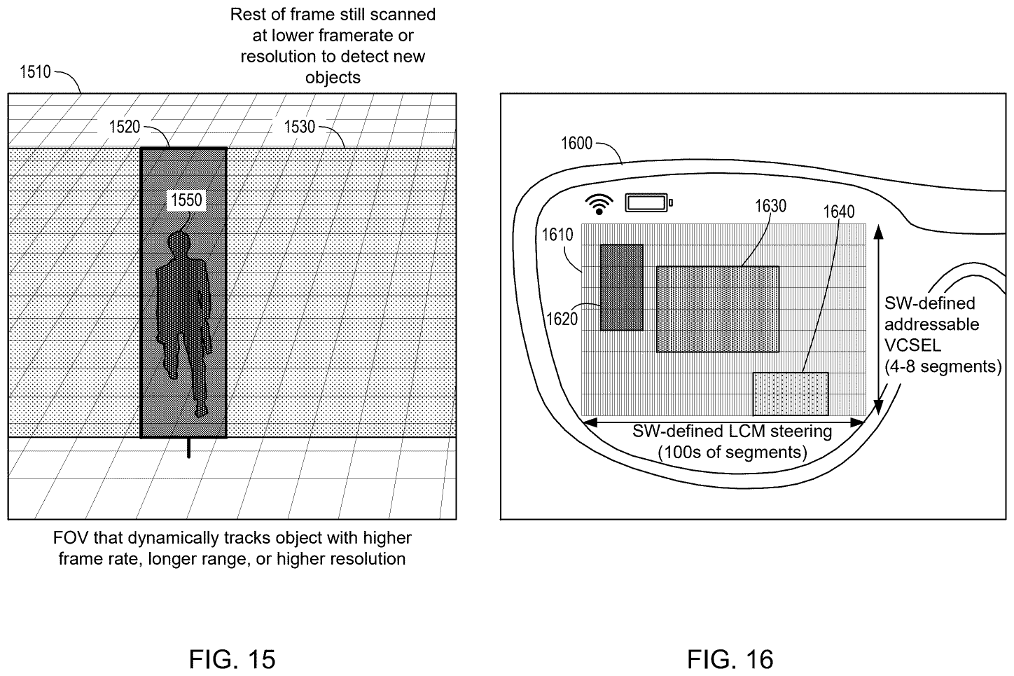

FIG. 16 illustrates a software-defined lidar system used in augmented reality glasses 1600, according to one embodiment. In the illustrated example, a software-defined lidar system includes a metasurface for high-resolution steering of optical radiation in a first direction that is detectable by a two-dimensional sensor. The software-defined lidar system includes a VCSEL laser assembly to provide limited steering (4-8 segments) of the optical radiation in the other dimension. Various ROIs, including ROIs 1620, 1630, and 1640 within the total field of view 1610, are defined in terms of steering angles and ROI scan parameters.

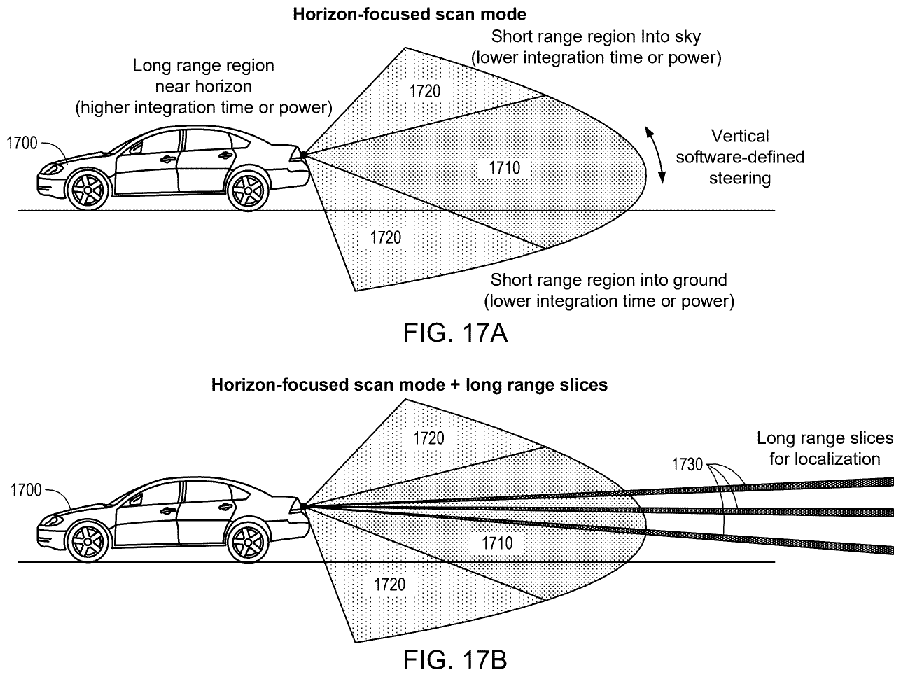

FIG. 17A illustrates a software-defined lidar system used in a vehicle 1700, according to one embodiment. In the illustrated embodiment, the software-defined lidar system can be operated in two different operational modes: a horizon-focused scan mode and a horizon-focused scan mode with long-range slices. In the horizon-focused scan mode, a peripheral ROI 1720 is used for short-range scanning of peripheral spatial areas, such as in directions toward the sky and into the ground. The ROI scan parameters of the peripheral ROI 1720 may, for example, specify a relatively low integration time and/or relatively low power laser pulse generation. A horizon ROI 1710 may be used to scan a spatial region directly behind the vehicle using ROI scan parameters that specify a higher resolution, longer range, higher frame rate, and/or the like.

FIG. 17B illustrates the software-defined lidar system implementing an additional long-range ROI 1730 that includes three slices of discontiguous steering angles for long-range scanning directly behind the vehicle using ROI scan parameters for the specific steering angles to provide high frame rates and long-range detection. Any number of physical sensors may be used to scan any number of different ROIs and/or provide data in the form of any number of virtual sensors. For example, sensors may be provided in front of a vehicle, behind a vehicle, below a vehicle, above a vehicle, on a driver's side of a vehicle, and/or on a passenger's side of a vehicle. Each sensor may scan different ROIs using specified scan parameters. The specified scan parameters may be modified in real-time in response to a perception stack, operate in a quasi-static configuration, and/or operate in a static configuration. For example, a given sensor may provide virtual scan data for two or more virtual sensors according to prespecified and unchanging scan parameters, or according to scan parameters that are modified in response to triggering events or predefined detection events.

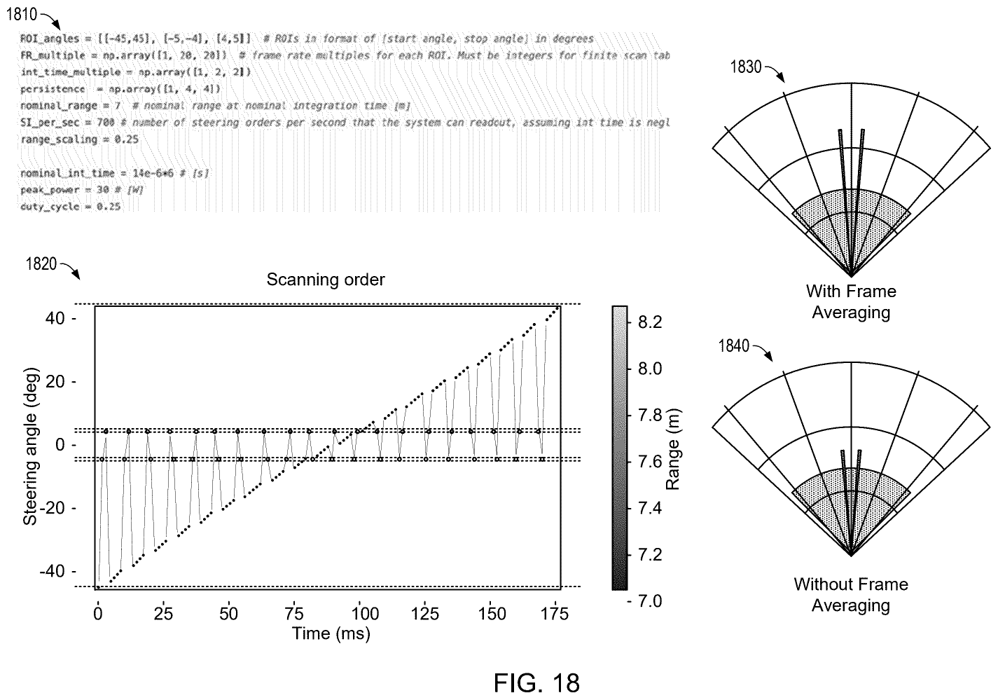

FIG. 18 illustrates diagrams of a lidar scan via a software-defined lidar system, according to one embodiment. An example scan definition 1810 is provided that identifies three ROIs and various ROI scan parameters for each of the three ROIs. The graph 1820 illustrates the steering angles implemented by the software-defined lidar system with respect to time. The diagram 1830 illustrates the lidar scan by the software-defined lidar system with frame averaging. Frame averaging may increase the range but reduce the frame rate. The diagram 1840 illustrates the same lidar scan by the software-defined lidar system without frame averaging.

In the illustrated embodiment, a first ROI is defined in the scan definition to include steering angles between −45 degrees and 45 degrees. The ROI scan parameters for the first ROI include a frame rate multiple of 1, an integration time multiple of 1, and a persistence of 1. General specifications for the nominal range value, number of steering orders per second, range scaling, nominal integration time, peak power levels, and duty cycle information may be specified or, in some cases, be based on the inherent specifications or limitations of the hardware utilized. A second ROI is defined to include steering angles between −5 degrees and −4 degrees, and a third ROI is defined to include steering angles between 4 and 5 degrees. Various other ROI scan parameters are listed in the definition 1810 for each of the first and second ROIs, including a frame multiple of 20, integration time multiple of 2, and a persistence of 4.

The graph 1820 illustrates the discontinuous scan implementation in which the transmitter subsystem of the software-defined lidar system steers the optical radiation to implement the specified ROIs. During the illustrated 175 milliseconds, a significant portion of the optical radiation is transmitted at steering angles corresponding to the second and third ROIs to attain the specified 20 frames for each frame of the first ROI that is captured.

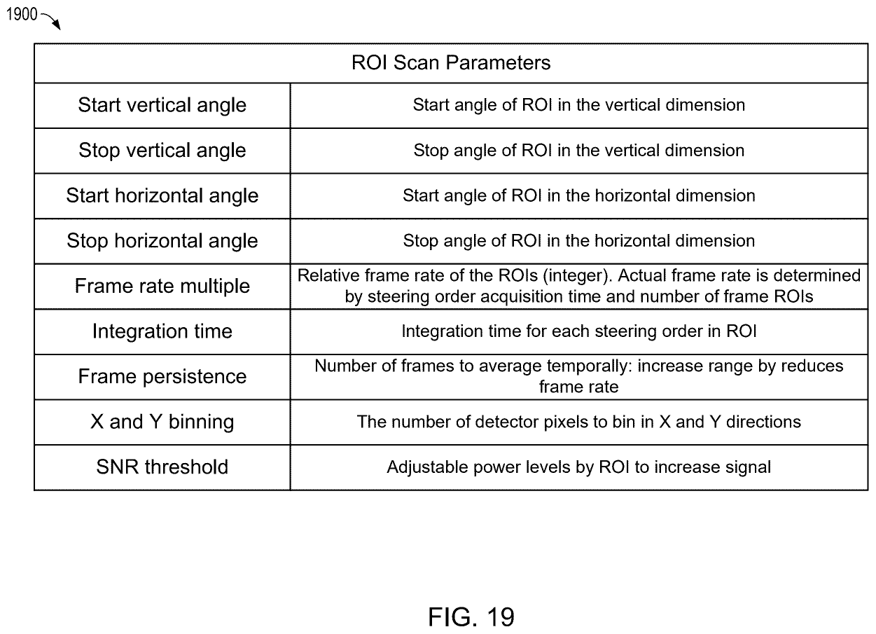

FIG. 19 illustrates a table 1900 of some example ROI scan parameters and associated descriptions, according to one embodiment. Examples of possible ROI scan parameters are not limited to those illustrated. The illustrated example includes a start vertical angle, a stop vertical angle, a start horizontal angle, a stop horizontal angle, a frame rate multiple, an integration time, a frame persistence, X and Y binning, and an SNR threshold value. It is appreciated that additional or alternative ROI scan parameters may be specified and/or otherwise utilized, some of which may be customized and others of which may be fixed or non-adjustable based on the specific hardware and/or conflicts with other defined scans. Additional examples of ROI scan parameters include, but are not limited to, the number of laser pulses, the frame rate, a measurement time, laser power, a pixel read window, pixel filtering levels, etc.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The following claims are also included as part of this disclosure.

What is claimed is:

1. A light detection and ranging (lidar) system, comprising:
a transmitter subsystem with a tunable optical metasurface to selectively steer optical radiation at various steering angles toward distant surfaces;
a receiver subsystem to receive reflected optical radiation from the distant surfaces; and
a controller to operate the transmitter subsystem and the receiver subsystem to:
scan a first region of interest (ROI) corresponding to a first set of steering angles with a first set of ROI scan parameters, and
scan a second ROI corresponding to a second set of the steering angles with a second set of the ROI scan parameters.

2. The system of claim 1, wherein the first set of steering angles of the first ROI includes a first subset of steering angles and a second subset of steering angles that are discontinuous with respect to one another, and wherein the second set of steering angles includes at least some steering angles that are between the first subset of steering angles and the second subset of steering angles.

3. The system of claim 1, wherein the ROI scan parameters comprise a steering scan resolution that defines an angular step size between steering angles, and wherein the controller operates to scan the first ROI with a first scan resolution and to scan the second ROI with a second resolution.

4. The system of claim 3, wherein the controller decreases the scan resolution by binning photodetectors of a sensor of the receiver subsystem, and wherein the controller increases the scan resolution by un-binning photodetectors of the sensor of the receiver subsystem.

5. The system of claim 1, wherein the ROI scan parameters comprise a scan frame rate, and wherein the controller operates to scan the first ROI with a first frame rate and to scan the second ROI with a second frame rate.

6. The system of claim 1, wherein the transmitter subsystem comprises a laser assembly to generate the optical radiation, wherein the ROI scan parameters comprise a power level of the optical radiation generated by the laser assembly, and wherein the controller operates to scan the first ROI with a first power level and to scan the second ROI with a second power level.

7. The system of claim 1, wherein the ROI scan parameters comprise an integration time per pixel of the receiver subsystem, and wherein the controller operates to scan the first ROI with a first integration time and to scan the second ROI with a second integration time.

8. The system of claim 1, wherein the ROI scan parameters comprise a scan range, and wherein the controller operates to scan the first ROI at a first range and to scan the second ROI with a second, longer range.

9. The system of claim 1, wherein the ROI scan parameters comprise a dwell time, and wherein the controller operates to scan the first ROI with a first dwell time at the first set of steering angles and to scan the second ROI with a second dwell time at the second set of steering angles.

10. The system of claim 1, wherein the metasurface comprises a one-dimensionally steerable metasurface, such that the first ROI is defined as one or more scan lines at the first set of steering angles and the second ROI is defined as one or more of scan lines at the second set of steering angles.

11. The system of claim 1, wherein the metasurface comprises a two-dimensionally steerable metasurface, wherein the first set of steering angles of the first ROI comprises a first set of two-dimensionally steered beamforms, and wherein the second set of steering angles of the second ROI comprises a second set of two-dimensionally steered beamforms.

12. The system of claim 1, the controller further operates the transmitter subsystem and the receiver subsystem to scan a third ROI corresponding to a third set of steering angles with a third set of scanning parameters.

13. The system of claim 1, wherein the ROI scan parameters comprise a number of laser pulses, and wherein the controller operates to scan the first ROI with a first number of laser pulses and to scan the second ROI with a second number of laser pulses.

14. A software-defined lidar (SWDL) system, comprising:
a single physical lidar device that includes:
a transmitter subsystem with a tunable optical metasurface to selectively steer optical radiation at various steering angles toward distant surfaces, and
a receiver subsystem to receive reflected optical radiation from the distant surfaces; and
a controller to control the operation of the single physical lidar device, wherein the controller is configured to:
receive one or more scan definitions from one or more requestors, including a first scan definition from a first requestor, wherein each scan definition specifies (i) a region of interest (ROI) corresponding to a set of steering angles of a single physical lidar device and (ii) associated ROI scan parameters,
scan, via the single physical lidar device, each ROI according to the associated ROI scan parameters to generate a virtual lidar sensor data set for each ROI, and
transmit the virtual lidar sensor data set of each ROI to each respective requestor, such that the first requestor receives the virtual lidar sensor data associated with the ROI of the first scan definition.

15. The system of claim 14, wherein the instructions, when executed by the processor of the controller, further cause the controller to:
receive a modification to the first scan definition from the first requestor that specifies one or more of (i) an updated ROI corresponding to an updated set of steering angles and (ii) updated ROI scan parameters.

16. The system of claim 14, wherein the controller scans each ROI by:
generating a plurality of scan table entries, wherein each scan table entry specifies a steering angle and at least one additional ROI scan parameter for the single physical lidar device; and
controlling the single physical lidar device to implement a non-sequential set of the scan table entries by repeating a scan cycle that includes:
identifying a scan table entry to be implemented next as a current scan table entry,
implementing the current scan table entry by controlling the single physical lidar to scan a portion of an ROI according to the current scan table entry,
capturing sensor data via a detection subsystem of the single physical lidar for the current scan table entry,
processing, via a perception stack, the sensor data for the current scan table entry to generate a perception output, and
identifying the next scan table entry to be implemented based on the perception output.

17. The system of claim 16, wherein the scan cycle further comprises modifying an ROI scan parameter of at least one scan table entry based on the perception output.

18. The system of claim 17, wherein modifying the ROI scan parameter of at least one scan table entry based on the perception output comprises modifying at least one of a laser power level and an integration time for the steering angle of the current scan table entry, and wherein identifying the next scan table entry to be implemented comprises identifying the modified current scan table entry, such that the current scan table entry is re-scanned with at least one of the modified laser power level and the modified integration time.

19. The system of claim 14, wherein the ROI scan parameters comprise one or more of a scan resolution, a frame rate, a refresh rate, a power level of generated optical radiation, an integration time, a scan range, a scan angle, a bias voltage of a receiver, number of laser pulses, and a dwell time.

20. The system of claim 14, wherein scan definitions from two different requestors include ROIs that at least partially overlap, and wherein the controller operates to send virtual lidar sensor data to both requestors from a single scan of the overlapping portion of the ROI.

21. A software-defined lidar (SWDL) system, comprising:
a single physical lidar device that includes:
a transmitter subsystem with a tunable optical metasurface to selectively steer optical radiation at various steering angles toward distant surfaces, and
a receiver subsystem to receive reflected optical radiation from the distant surfaces;
a controller to control the operation of the single physical lidar device; and
a non-transitory computer-readable medium with instructions stored thereon that, when executed by a processor of the controller, cause the controller to:
scan, via the transmitter and receiver subsystems, a first region of interest (ROI) corresponding to a first set of steering angles with a first set of ROI scan parameters to generate sensor data for the first ROI,
scan, via the transmitter and receiver subsystems, a second ROI corresponding to a second set of steering angles with a second set of ROI scan parameters to generate sensor data for the second ROI,
process, via a first perception stack, the sensor data for the first ROI to generate a first set of perception outputs, and
modify one or more of the first set of steering angles and the first set of ROI scan parameters of the first ROI based on the first set of perception outputs.

22. The system of claim 21, wherein the first ROI comprises a spatial region directly in front of or directly behind a vehicle, and wherein the second ROI comprises a peripheral spatial region relative to the vehicle.

23. The system of claim 21, wherein the first ROI comprises a spatial region directly in on a side of a vehicle, and wherein the second ROI comprises a peripheral spatial region relative to the vehicle.

24. The system of claim 21, wherein the instructions, when executed by the processor of the controller, further cause the controller to:
scan a third ROI corresponding to a third set of discontiguous steering angles that are directly behind or directly in front of a vehicle with a third set of ROI scan parameters for long-range detection.

25. The system of claim 24, wherein the instructions, when executed by the processor of the controller, cause the controller to:
implement a discontiguous scanning order of the steering angles of the first, second, and third sets of steering angles.

26. The system of claim 21, wherein the first ROI comprises a set of steering angles corresponding to a detected location of an object of interest with a spatial region, and the second ROI comprises a set of steering angles corresponding to spatial regions peripheral to the object of interest.

27. The system of claim 26, wherein the first set of perception outputs identifies movement of the object of interest relative to the single physical lidar device and wherein the controller modifies the first set of steering angles of the first ROI based on the identified movement of the object of interest.

28. The system of claim 27, wherein the object of interest comprises one of a person, a sign, a positioning beacon, an animal, and a vehicle, and wherein the first set of steering angles of the first ROI is modified to track the object of interest as it moves relative to the single physical lidar device.

29. The system of claim 26, wherein the first set of ROI scan parameters of the first ROI includes a higher frame rate than a frame rate specified in the second ROI scan parameters of the second ROI.

30. The system of claim 29, wherein the object of interest comprises a hand of a user, such that a higher frame rate is used to scan the hand of the user than the frame rate used to scan the peripheral spatial regions.
